(19) United States
(12) Patent Application Publication
(10) Pub. No.: US 2017/0183504 A1
(43) Pub. Date: Jun. 29, 2017

(54) HARDCOAT FILM, METHOD FOR MANUFACTURING HARDCOAT FILM, POLARIZING PLATE, AND LIQUID CRYSTAL DISPLAY DEVICE

(71) Applicant: FUJIFILM Corporation, Tokyo (JP)

(72) Inventors: Keigo UEKI, Kanagawa (JP); Naoya NISHIMURA, Kanagawa (JP); Kazuo KAMOHARA, Kanagawa (JP); Katsuyuki TAKADA, Kanagawa (JP)

(73) Assignee: FUJIFILM Corporation, Tokyo (JP)

(21) Appl. No.: 15/460,883

(22) Filed: Mar. 16, 2017

Related U.S. Application Data
(63) Continuation of application No. PCT/JP2015/077638, filed on Sep. 29, 2015.

(30) Foreign Application Priority Data
Sep. 30, 2014 (JP) 2014-202476

(51) Int. Cl. C09D 4/00; G02F 1/1335; C08J 7/16; G02B 1/14

(52) U.S. Cl. CPC C09D 4/00; G02B 1/14; G02F 1/133528; C08J 7/16; C08J 2301/10; C08J 2333/10; C08J 2435/02

(57) ABSTRACT

Provided is a hardcoat film having a film thickness of 25 μm or less in which a polymerized substance of a compound having an energy ray-curable group and a resin are mixed across an entire region in a film thickness direction, in which a percentage of a mass concentration of the resin which is represented by the Expression (1) as defined herein has a distribution in which the percentage is maximized on at least one of two opposed surfaces, in the film thickness direction, of the hardcoat film or at a central part, in the film thickness direction, of the hardcoat film.

### CROSS REFERENCE TO RELATED APPLICATION

This is a continuation of International Application No. PCT/JP2015/077638 filed on Sep. 29, 2015, and claims priority from Japanese Patent Application No. 2014-202476 filed on Sep. 30, 2014, the entire disclosures of which are incorporated herein by reference.

### BACKGROUND OF THE INVENTION

1. Field of the Invention

The present invention relates to a hardcoat film, a method for manufacturing a hardcoat film, a polarizing plate, and a liquid crystal display device.

2. Description of the Related Art

In image display devices such as cathode ray tube (CRT) display devices, plasma display panels (PDP), electroluminescent displays (ELD), vacuum fluorescent displays (VFD), field emission displays (FED), and liquid crystal display (LCD) devices, hardcoat films are preferably provided in order to prevent damaging on display surfaces.

Hardcoat films obtained by applying a composition for forming a hardcoat layer including a curable compound such as polyfunctional acrylate onto a translucent support including a resin such as cellulose acylate and curing the composition so as to form a hardcoat layer are known.

However, in recent years, thickness reduction has been underway for image display devices, and, accordingly, there has been a strong demand for thickness reduction for hardcoat films. In order to reduce the thickness of hardcoat films, it is necessary to reduce the thickness of translucent supports, but it is known that, as the thickness of translucent supports is reduced, the influence of shrinkage in the width direction occurring during the curing of hardcoat layers become more significant, and thus striped wrinkles or curls which are parallel to the transportation direction are generated and deteriorate visibility. Therefore, there has been a demand for improvement.

Regarding the improvement in the visibility of hardcoat films, improvements have been proposed from more various viewpoints than in the related art, and, for example, JP5245688B describes that, in methods for manufacturing hardcoat films, the leveling of films is improved by radiating ultraviolet rays from two or more lamps.

In addition, as a method for improving uneven interference, JP2006-293279A describes a method in which the interface between a support and a hardcoat layer is substantially eliminated by applying a permeable composition for the hardcoat layer, thereby improving visibility.

### SUMMARY OF THE INVENTION

However, although JP5245688B describes the leveling of films, the striped wrinkles are a different issue from the object studied in JP5245688B, and wrinkles are not eliminated even when ultraviolet rays are radiated from two or more lamps.

An object of the present invention is to provide a hardcoat film having a film thickness of 25 μm or less in which uneven interference, curls, and striped wrinkles are all significantly suppressed and a method for manufacturing the hardcoat film. In addition, another object of the present invention is to provide a polarizing plate and a liquid crystal display device which include the hardcoat film and of which the display quality is not impaired due to uneven interference, curls, and striped wrinkles.

The objects of the present invention can be achieved by the present invention which is the following means.

[1] A hardcoat film having a film thickness of 25 μm or less in which a polymerized substance of a compound having an energy ray-curable group and a resin are mixed across an entire region in a film thickness direction, in which a percentage of a mass concentration of the resin which is represented by Expression (1) below has a distribution in which the percentage is maximized on at least one surface or in a central part in the film thickness direction:

(the mass concentration of the resin)/{(a mass concentration of the polymerized substance of the compound having an energy ray-curable group)+(the mass concentration of the resin)}×100(%) Expression (1)

[2] The hardcoat film according to [1], in which the percentage of the mass concentration of the resin is 70% or less on at least one surface.

[3] The hardcoat film according to [1] or [2], in which the percentage of the mass concentration of the resin is minimized on one surface and maximized on the other surface.

[4] The hardcoat film according to [3], in which the percentages of the mass concentration of the resin on both surfaces are different from each other by 10% to 85%.

[5] The hardcoat film according to [1] or [2], in which the percentage of the mass concentration of the resin is maximized in the central part.

[6] The hardcoat film according to any one of [1] to [5], in which the resin is cellulose acylate.

[7] The hardcoat film according to any one of [1] to [5], in which the resin is a (meth)acrylic polymer.

[8] The hardcoat film according to any one of [1] to [7], in which the compound having an energy ray-curable group is a compound having at least one of an ethylenic unsaturated double-bonding group or an epoxy group.

[9] The hardcoat film according to any one of [1] to [8], in which the compound having an energy ray-curable group is a compound having one or more epoxy groups and one or more ethylenic unsaturated double-bonding groups in a molecule.

[10] The hardcoat film according to any one of [1] to [9], in which the compound having an energy ray-curable group is a compound having one or more (meth)acryloyl groups in a molecule.

[11] The hardcoat film according to any one of [1] to [10], in which a molecular weight of the compound having an energy ray-curable group is 600 or less.

[12] A method for manufacturing the hardcoat film according to any one of [1] to [11], comprising: applying a composition for forming a hardcoat layer including a compound having an energy ray-curable group onto a translucent support including a resin which has a film thickness of 25 μm or less from at least one surface to be permeated across an entire region in a thickness direction of the translucent support; and then curing the compound having an energy ray-curable group by radiating ionizing radiation.

[13] A polarizing plate comprising: a polarizer; and at least one hardcoat film according to any one of [1] to [11].

[14] A liquid crystal display device comprising: at least one hardcoat film according to any one of [1] to [11] or at least one polarizing plate according to [13].

According to the present invention, it is possible to provide a hardcoat film having a film thickness of 25 μm or less in which uneven interference, curls, and striped wrinkles are all significantly suppressed and a method for manufacturing the hardcoat film. In addition, it is also possible to provide a polarizing plate and a liquid crystal display device which include the hardcoat film and of which the display quality is not impaired due to uneven interference, curls, and striped wrinkles.

### DESCRIPTION OF THE PREFERRED EMBODIMENTS

In some cases, constituent requirements described below will be described on the basis of typical embodiments of the present invention, but the present invention is not limited to those embodiments. Meanwhile, in the present specification, numerical ranges expressed using “to” includes numerical values before and after the “to” as the lower limit value and the upper limit value. “(Meth)acrylic resins” refer to resins obtained by polymerizing derivatives of methacrylic acid or acrylic acid and resins containing the above-described derivatives. In addition, unless particularly otherwise described, “(meth)acrylates” represent acrylates and methacrylates, and “(meth)acryl” represent acryl and methacryl.

A hardcoat film of the present invention is a hardcoat film having a film thickness of 25 μm or less in which a polymerized substance of a compound having an energy ray-curable group and a resin are mixed across the entire region in the film thickness direction, in which the percentage of the concentration of the resin which is represented by Expression (1) below has a distribution in which the percentage is maximized on at least one surface or in the central part in the film thickness direction:

(the concentration of the resin)/{(the concentration of the polymerized substance of the compound having an energy ray-curable group)+(the concentration of the resin)}×100(%) Expression(1)

Meanwhile, the “resin” is preferably a thermoplastic resin and is different from the “polymerized substance of a compound having an energy ray-curable group”.

In hardcoat films having a film thickness of 25 μm or less, when a polymerized substance of a compound having an energy ray-curable group and a resin are mixed together across the entire region in the film thickness direction, it is possible to obtain hardcoat films in which the generation of uneven interference and striped wrinkles and curls is significantly suppressed.

Striped wrinkles are considered to be attributed to stresses generated in a translucent support including a resin due to the cure shrinkage of a curable compound when a composition for forming a hardcoat layer including the curable compound is applied and cured on the translucent support so as to form a hardcoat layer. As the thickness of the translucent support decreases, the influence of shrinkage in the hardcoat layer increases. In a case in which a hardcoat layer is provided on a translucent support, it is considered that shrinkage stress is concentratedly applied only to one side of a film and thus striped wrinkles are likely to be generated. Meanwhile, in a case in which a curable compound is infiltrated into the entire translucent support, shrinkage stress is distributed throughout the entire film, and thus it is considered that the generation of striped wrinkles is suppressed. Therefore, in the hardcoat film of the present invention, it is considered that the generation of uneven interference and striped wrinkles and curls is suppressed while the hardcoat film has a thin thickness.

The hardcoat film of the present invention is a hardcoat film in which a polymerized substance of a compound having an energy ray-curable group and a resin are mixed across the entire region in the film thickness direction, and the percentage of the concentration of the resin which is represented by Expression (1) is greater than 0% and smaller than 100% in the entire region of the hardcoat film.

On both surfaces of the hardcoat film, the percentage of the concentration of the resin which is represented by Expression (1) is preferably not 0%. In addition, on at least one surface, the percentage of the concentration of the resin which is represented by Expression (1) is preferably 70% or less, more preferably 30% or less, and still more preferably 5% or less.

In the hardcoat film of the present invention, it is preferable that the percentage of the concentration of the resin is minimized on one surface and gradually increases toward the other surface and is thus maximized on the other surface.

The difference in the percentage of the concentration of the resin between both surfaces is preferably 10% to 85%, more preferably 10% to 60%, and still more preferably 10% to 30%.

When the difference in the percentage of the concentration is 10% or more, it is possible to suppress the generation of uneven interference or striped wrinkles, and, when the difference is 85% or less, curls are suppressed, which is preferable.

As another aspect of the hardcoat film of the present invention, the percentage of the concentration of the resin is preferably maximized in the central part in the film thickness direction.

When the percentages of the concentration of the polymerized substance of the compound having an energy ray-curable group increase on both surfaces, it is possible to suppress the generation of striped wrinkles or curls.

Hereinafter, individual components included in the hardcoat film will be described in detail.

(Polymerized Substance of Compound Having Energy Ray-Curable Group)

The polymerized substance of the compound having an energy ray-curable group is formed by polymerizing compounds having an energy ray-curable group.

[Compound Having Energy Ray-Curable Group]

The compound having an energy my-curable group will be described. The compound having an energy ray-curable group will also be referred to as “compound (a)”.

The compound (a) has one or more energy ray-curable groups in the molecule, preferably has two or more energy ray-curable groups in the molecule, and more preferably has three or more energy ray-curable groups in the molecule. When having three or more energy ray-curable groups in the molecule, the compound (a) is capable of developing high hardness.

Examples of the energy ray-curable group include radical polymerizable groups such as (meth)acryloyl groups, vinyl groups, styryl groups, and allyl groups and polymerizable functional groups such as epoxy groups. Among these, (meth)acryloyl groups, —C(O)OCH═C, and epoxy groups are preferred, and (meth)acryloyl groups and epoxy groups are particularly preferred.

Examples of the compound (a) include esters of a polyhydric alcohol and a (meth)acrylic acid, vinyl benzene, derivatives thereof, vinyl sulfone, (meth)acrylamides, and the like. Among these, compounds having one or more (meth)acryloyl groups in the molecule are preferred from the viewpoint of hardness, and examples thereof include acrylate-based compounds forming high-hardness cured substances that are broadly used in the present industrial field. Examples of the above-described compounds include esters of a polyhydric alcohol and a (meth)acrylic acid, for example, pentaerythritol tetra(meth)acrylates, pentaerythritol tri(meth)acrylates, trimethylolpropane tri(meth)acrylates, EO-modified trimethylolpropane tri(meth)acrylates, PO-modified trimethylolpropane (meth)acrylates, EO-modified tri(meth)acrylate phosphates, trimethylolethane tri(meth)acrylates, ditrimethylolpropane tetra(meth)acrylates, dipentaerythritol tetra(meth)acrylates, dipentaerythritol penta(meth)acrylates, dipentaerythritol hexa(meth)acrylates, pentaerythritol hexa(meth)acrylates, 1,2,3-cyclohexane tetramethacrylate, polyurethanepolyacrylate, polyester polyacrylate, caprolactone-modified tris(acryloxyethyl) isocyanurate, and the like.

Examples of specific compounds of polyfunctional acrylate-based compounds having three or more (meth)acryloyl groups include esterified substances of a polyol such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, KAYARAD GPO-303 manufactured by Nippon Kayaku Co., Ltd., V#400, or V#36095D manufactured by Osaka Organic Chemical Industry Ltd. and a (meth)acrylic acid. In addition, it is also possible to preferably use tri- or higher-functional urethane acrylate compounds of SHIKOH UV-1400B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, SHIKOH UV-2250EA, SHIKOH UV-2750B (manufactured by Nippon Synthetic Chemical Industry Co., Ltd.), UL-503LN (manufactured by Kyoeisha Chemical Co., Ltd.), UNIDIC 17-806, UNIDIC 17-813, UNIDIC V-4030, UNIDIC V-4000BA (manufactured by Dainippon Printing Ink Manufacturing), EB-1290K, EB-220, EB-5129, EB-1830, EB-4358 (manufactured by Daicel-UCB Company, Ltd.), HIGH-COAP AU-2010, HIGH-COAP AU-2020 (manufactured by Tokushiki Co., Ltd.), ARONIX M-1960 (manufactured by Toagosei Co., Ltd.), ART RESIN UN-3320HA, UN-3320HC, UN-3320HS, UN-904, and HDP-4T, tri- or higher-functional polyester compounds of ARONIX M-8100, M-8030, M-9050 (manufactured by Toagosei Co., Ltd.), and KBM-8307 (manufactured by Daicel Cytec Co., Ltd.), and the like.

In addition, the compound (a) may be constituted of a single compound or a combination of a plurality of compounds can also be used.

In addition, as the compound (a), in addition to the compound having a (meth)acryloyl group, a compound having one or more epoxy groups in the molecule is also preferably used. When the compound (a) includes an epoxy group, it is possible to obtain hardcoat films having low moisture permeability.

The compound (a) having one or more epoxy groups in the molecule is preferably a compound represented by General Formula (1) below.

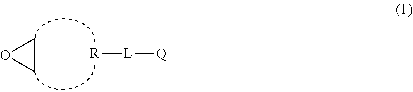

In General Formula (1), R represents a monocyclic hydrocarbon or a crosslinked hydrocarbon, L represents a single bond or a divalent linking group, and Q represents an ethylenic unsaturated double-bonding group or a ring-opening polymerizable group. Meanwhile, L may not be present, and R and Q may be directly bonded to each other.

In a case in which R in General Formula (1) is a monocyclic hydrocarbon, the monocyclic hydrocarbon is preferably an alicyclic hydrocarbon, and, among the alicyclic hydrocarbon, an alicyclic group having 4 to 10 carbon atoms is more preferred, an alicyclic group having 5 to 7 carbon atoms is still more preferred, and an alicyclic group having 6 carbon atoms is particularly preferred. Specifically, a cyclobutyl group, a cyclopentyl group, a cyclohexyl group, or a cycloheptyl group is preferred, and a cyclohexyl group is particularly preferred.

In a case in which R in General Formula (1) is a crosslinked hydrocarbon, a bicyclic crosslink (bicyclo ring) or a tricyclic crosslink (tricyclo ring) is preferred, and examples thereof include crosslinked hydrocarbons having 5 to 20 carbon atoms. Examples thereof include norbornyl groups, bornyl groups, isobornyl groups, tricyclodecyl groups, dicyclopentenyl groups, dicyclopentanyl groups, tricyclopentenyl groups, tricyclopentanyl groups, adamantyl groups, lower alkyl group-substituted adamantyl group, and the like.

In a case in which L represents a divalent linking group, a divalent aliphatic hydrocarbon group is preferred. The number of carbon atoms in the divalent aliphatic hydrocarbon group is preferably 1 to 6, more preferably 1 to 3, and still more preferably 1. The divalent aliphatic hydrocarbon group is preferably a linear, branched, or cyclic alkylene group, more preferably a linear or branched alkylene group, and still more preferably a linear alkylene group.

Examples of Q include ethylenic unsaturated double-bonding groups such as (meth)acryloyl groups, vinyl groups, styryl groups, and allyl groups, ring-opening polymerizable functional groups such as cyclohexene oxide groups and glycidyl ether groups, and, among these, (meth)acryloyl groups, —C(O)OCH═CH₂, cyclohexene oxide groups, and glycidyl ether groups are preferred, and (meth)acryloyl groups, cyclohexene oxide groups, and glycidyl ether groups are particularly preferred.

Specific compounds of the compound (a) are not particularly limited as long as the compound has one or more alicyclic epoxy groups or one ethylenic unsaturated double-bonding group in the molecule, and it is possible to use compounds described in Paragraph “0015” of JP1998-17614A (JP-H10-17614A) or represented by General Formula (1A) or (1B) below, 1,2-epoxy-4-vinylcyclohexane, vinylcyclohexene dioxide, pentaerythritol tetraacrylate, 3,4-epoxycyclohexane, and the like.

Among these, the compounds represented by General Formula (1A) or (1B) below are more preferred, and the compounds represented by General Formula (1A) below which have a low molecular weight are still more preferred. Meanwhile, isomers of the compounds represented by General Formula (1A) below are also preferred. In General Formula (1A) below, L₂ represents a divalent aliphatic hydrocarbon group having 1 to 6 carbon atoms and more preferably has 1 to 3 carbon atoms and still more preferably has one carbon atom (epoxycyclohexylmethyl (metha)acrylate). When the above-described compounds are used, visibility is excellent.

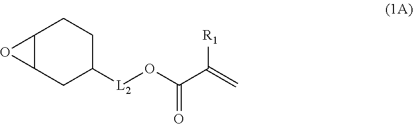

In General Formula (1A), R₁ represents a hydrogen atom or a methyl group, and L₂ represents a divalent aliphatic hydrocarbon group having 1 to 6 carbon atoms.

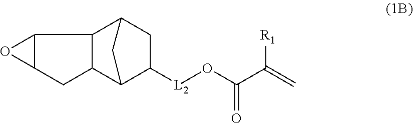

In General Formula (1B), R₁ represents a hydrogen atom or a methyl group, and L₂ represents a divalent aliphatic hydrocarbon group having 1 to 3 carbon atoms.

The divalent aliphatic hydrocarbon group as L₂ in General Formulae (1A) and (1B) has 1 to 6 carbon atoms, more preferably has 1 to 3 carbon atoms, and still more preferably has one carbon atom. The divalent aliphatic hydrocarbon group is preferably a linear, branched, or cyclic alkylene group, more preferably a linear or branched alkylene group, and still more preferably a linear alkylene group.

The molecular weight of the compound (a) is not particularly limited, but is preferably 600 or less and more preferably 360 or less. When the molecular weight is set to 600 or less, it is possible to prevent hardness deterioration, the compound is capable of favorably permeating into a translucent support described below, it is easy to produce the hardcoat film of the present invention, and films having excellent visibility can be obtained.

In addition, the molecular weight of the compound (a) is preferably 80 or more and more preferably 120 or more since volatilization is suppressed during the formation of the hardcoat film.

The content of the polymerized substance of the compound (a) is preferably 25% to 85% by mass and more preferably 49% to 85% by mass in a case in which the total solid content of the hardcoat film is set to 100% by mass.

[Resin]

The hardcoat film of the present invention includes a resin. The resin is preferably a thermoplastic resin having excellent translucency, mechanical strength, heat stability, isotropy, and the like. Excellent translucency means that the transmittance of visible light is 60% or more, preferably 80% or more, and particularly preferably 90% or more. Examples thereof include polycarbonate-based polymers, polyester-based polymers such as polyethylene terephthalate and polyethylene naphthalate, (meth)acrylic polymers such as polymethyl methacrylate, styrene-based polymers such as polystyrene and acrylonitrile.styrene copolymers (AS resins), and the like. In addition, examples thereof also include polyolefins such as polyethylene and polypropylene, polyolefin-based polymers such as ethylene-propylene copolymers, vinyl chloride-based polymers, amide-based polymers such as nylon and aromatic polyamides, imide-based polymers, sulfone-based polymers, polyether sulfone-based polymers, polyether ether ketone-based polymers, polyphenylene sulfide-based polymers, vinylidene chloride-based polymers, vinyl butyral-based polymers, arylate-based polymers, polyoxymethylene-based polymers, epoxy-based polymers, and polymers obtained by mixing the above-described polymers.

The thermoplastic resin is particularly preferably a cellulose-based polymer represented by triacetyl cellulose (particularly preferably cellulose acylate). In addition, (meth)acrylic polymers, which have been proposed in recent years to be introduced as a polarizing plate protective film, are also preferred.

The content of the resin is preferably 15% to 75% by mass and more preferably 15% to 51% by mass in a case in which the total solid content of the hardcoat film is set to 100% by mass.

The resin is preferably derived from a translucent support in a method for manufacturing the hardcoat film described below.

[Method for Manufacturing Hardcoat Film]

A method for manufacturing the hardcoat film of the present invention is a method for manufacturing a hardcoat film including: applying a composition for forming a hardcoat layer including a compound having an energy ray-curable group onto a translucent support including a resin which has a film thickness of 25 μm or less from at least one surface to be permeated across the entire region in the thickness direction of the translucent support; and then curing the compound having an energy ray-curable group by radiating ionizing radiation.

The compound having an energy ray-curable group in the composition for forming a hardcoat layer is the same as the above-described compound having the energy ray-curable group.

The resin in the translucent support including a resin is the same as the resin in the hardcoat film.

The translucent support is formed of the above-described resin and has a film thickness of 25 μm or less.

When the composition for forming a hardcoat layer is permeated into the translucent support across the entire region in the film thickness direction of the translucent support by applying the composition for forming a hardcoat layer on one or both surfaces of the translucent support, a state in which the compound (a) and the translucent support (resin) are mixed together across the entire region in the film thickness direction is formed.

Ionizing radiation is radiated to the translucent support so as to cure the compound (a), it is possible to obtain a hardcoat film having a film thickness of 25 μm or less in which the polymerized substance of the compound having the energy ray-curable group and the resin are mixed across the entire region in the film thickness direction.

It is preferable that the composition for forming a hardcoat layer is all permeated into the translucent support and a layer only made of the composition for forming a hardcoat layer and a layer only made of the resin are not formed on the surface of the obtained hardcoat film.

When the obtained film is cut, the cross-section is etched and then observed using SEM, the film thickness of the film or the presence or absence of the respective layers can be confirmed.

In the hardcoat film obtained using the above-described manufacturing method, the percentage of the concentration of the resin represented by Expression (i) is more than 0% and less than 100% on both surfaces. In addition, the percentage of the concentration of the resin represented by Expression (1) is preferably 70% or less, more preferably 30% or less, and still more preferably 5% or less on at least one surface.

On the surface (coated surface) of the hardcoat film obtained using the above-described manufacturing method to which the composition for forming a hardcoat layer is applied, the percentage of the concentration of the resin is preferably 70% or less, more preferably 30% or less, and still more preferably 5% or less.

As an aspect of the hardcoat film of the present invention, it is preferable that the percentage of the concentration of the resin is minimized on one surface and gradually increases toward the other surface and is thus maximized on the other surface, and it is preferable that the percentage of the concentration of the resin is minimized on the surface (coated surface) to which the composition for forming a hardcoat layer is applied and is maximized on the surface (non-coated surface) opposite to the surface to which the composition for forming a hardcoat layer is applied.

The percentage of the concentration of the resin on the coated surface is preferably 5% to 70%, more preferably 5% to 50%, and still more preferably 5% to 30%.

The percentage of the concentration of the resin on the non-coated surface is preferably 30% to 95%, more preferably 30% to 80%, and still more preferably 30% to 70%.

The difference in the percentage of the concentration of the resin between the coated surface and the non-coated surface is preferably 10% to 85%, more preferably 10% to 60%, and still more preferably 10% to 30%.

When the difference in the percentage of the concentration is 10% or more, it is possible to suppress the generation of uneven interference or striped wrinkles; however, when the difference is more than 85%, curls become large, which is not preferable.

As another aspect of the hardcoat film of the present invention, the percentage of the concentration of the resin is preferably maximized in the central part in the film thickness direction.

The difference in the percentage of the concentration of the resin between both surfaces is not particularly limited, but is preferably zero.

When the percentage of the concentration of the resin is maximized in the central part in the film thickness direction, and the percentages of the concentration of the polymerized substance of the compound having the energy ray-curable group become great on both surfaces, it is possible to suppress the generation of striped wrinkles or curls.

The composition for forming a hardcoat layer may include components other than the compound (a).

[Polymerization Initiator]

The composition for forming a hardcoat layer may include a polymerization initiator.

Compounds having an ethylenic unsaturated group can be polymerized together by means of radiation of ionizing radiation or heating in the presence of a polymerization initiator. As the polymerization initiator, it is possible to use commercially available compounds which are described in “Advanced UV Curing Technologies” (p. 159, publisher; Kazuhiro Takausu, Publishing company; Technical Information Institute Co., Ltd., published in 1991) or catalogues of Ciba Specialty Chemicals K. K.

As the polymerization initiator, it is possible to use a radical polymerization initiator or a cationic polymerization initiator.

Specifically, as the radical polymerization initiator, it is possible to use alkylphenone-based photopolymerization initiators (Irgacure651, Irgacure184, DAROCURE1173, Irgacure2959, Irgacure127, DAROCURE MBF, Irgacure907, Irgacure369, and Irgacure379EG), acylphosphine oxide-based photopolymerization initiators (Irgacure819 and LUCIRIN TPO), others (Irgacure784, Irgacure OXE01, Irgacure OXE02, and Irgacure754), and the like.

The amount of the radical polymerization initiator added is in a range of 0.1% to 10% by mass, preferably 1% to 5% by mass, and more preferably 2% to 4% by mass in a case in which the total solid content of the composition for forming a hardcoat layer in the present invention is set to 100% by mass. In a case in which the amount of the radical polymerization initiator added is less than 0.1% by mass, polymerization does not sufficiently proceed, and the hardness of the hardcoat layer is insufficient. On the other hand, in a case in which the amount of the radical polymerization initiator added is more than 10% by mass, UV light does not reach the inside of the film, and the hardness of the hardcoat layer is insufficient. The radical initiator may be used singly, or a combination of a plurality of radical polymerization initiators can also be used.

Examples of the cationic polymerization initiator include well-known acid-generating agents and well-known compounds which are used in light initiators for light cationic polymerization, light color extinction agents and light discoloring agents of coloring agents, micro-resists, and the like, mixtures thereof, and the like.

Examples thereof include onium compounds, organic halogen compounds, and disulfone compounds. Specific examples of the organic halogen compounds and the disulfone compounds include the same compounds as described in the section of the above-described radical-generating compounds.

Examples of the onium compounds include diazonium salts, ammonium salts, iminium salts, phosphonium salts, iodonium salts, sulfonium salts, arsonium salts, selenonium salts, and the like, and examples thereof include compounds described in Paragraphs “0058” and “0059” of JP2002-29162A.

The cationic polymerization initiator that is particularly preferably used in the present invention, is an onium salt, diazonium salts, iodonium salts, sulfonium salts, and iminium salts are preferred from the viewpoint of the light sensitivity of photopolymerization initiation, the material stability of compounds, and the like, and, among these, iodonium salts are most preferred from the viewpoint of light resistance.

Specific examples of the onium salts that are preferably used in the present invention include amylated sulfonium salts described in Paragraph “0035” of JP1997-268205A (JP-H09-268205A), diaryliodonium salts and triarylsulfonium salts described in Paragraphs “0010” and “0011” of JP2000-71366A, sulfonium salts of thiobenzoate S-phenyl ester described in Paragraph “0017” of JP2001-288205A, onium salts described in Paragraphs “0030” to “0033” of JP2001-133696A, and the like.

Additional examples thereof include organic metal/organic halides described in Paragraphs “0059” to “0062” of JP2002-29162A, photoacid generators having an o-nitrobenzyl-type protective group, compounds such as compounds that are light-decomposed and thus generate sulfonic acid (iminosulfonate and the like).

As specific compounds of iodonium salt-based cationic polymerization initiators, it is possible to use B2380 (manufactured by Tokyo Chemical Industry Co., Ltd.), BBI-102 (manufactured by Midori Kagaku Co., Ltd.), WPI-113 (manufactured by Wako Pure Chemical Industries, Ltd.), WPI-124 (manufactured by Wako Pure Chemical Industries, Ltd.), WPI-169 (manufactured by Wako Pure Chemical Industries, Ltd.), WPI-170 (manufactured by Wako Pure Chemical Industries, Ltd.), DTBPI-PFBS (manufactured by Toyo Gosei Co., Ltd.), DTBPI-CS (manufactured by Toyo Gosei Co., Ltd.), and PI-2074 (manufactured by Rhodia Japan Co., Ltd.).

The cationic polymerization initiator may be used singly, or two or more cationic polymerization initiators may be jointly used.

The amount of the cationic polymerization initiator added is in a range of 0.1% to 10% by mass and can be preferably 0.3% to 3.0% by mass in a case in which the total solid content of the composition for forming a hardcoat layer in the present invention is set to 100% by mass. The amount of the cationic polymerization initiator added is preferably in the above-described range from the viewpoint of the stability, polymerization reactivity, and the like of curable compositions.

[e) Inorganic Fine Particles Having Reactivity to Epoxy Group or Ethylenic Unsaturated Double-Bonding Group]

To the composition for forming a hardcoat layer in the present invention, e) inorganic fine particles having reactivity to epoxy groups or ethylenic unsaturated double-bonding groups are preferably added. The inorganic fine particles having reactivity to epoxy groups or ethylenic unsaturated double-bonding groups e) will also be referred to as component e). The addition of inorganic fine particles enables a decrease in the cure shrinkage amount of cured layers and thus enables a decrease in film curling. Furthermore, when the inorganic fine particles having reactivity to epoxy groups or ethylenic unsaturated double-bonding groups are used, it is possible to improve pencil hardness. Examples of the inorganic fine particles include silica particles, titanium dioxide particles, zirconium oxide particles, aluminum oxide particles, and the like. Among these, silica particles are preferred.

Generally, inorganic fine particles have a low affinity to organic components such as polyfunctional vinyl monomers, and thus, when simply mixed into the composition, may form aggregates or cause cured layers after curing to be easily cracked in some cases. Therefore, for the component e) in the present invention, in order to increase the affinity between the inorganic fine particles and organic components, the surfaces of the inorganic fine particles are treated using a surface modifier including organic cement.

The surface modifier preferably has a functional group capable of forming bonds with the inorganic fine particles or being adsorbed to the inorganic fine particles and a functional group having a high affinity to organic components in the same molecule. The surface modifier having a functional group capable of forming bonds with inorganic fine particles or being adsorbed to the inorganic fine particles is preferably a metal alkoxide surface modifier such as silane, aluminum, titanium, or zirconium or a surface modifier having an anionic group such as a phosphoric acid group, a sulfuric acid group, a sulfonic acid group, or a carboxylic acid group. Furthermore, the functional group having a high affinity to organic components may be a functional group simply having the same hydrophilicity or hydrophobicity as organic components, but is preferably a functional group capable of being chemically bonded with organic components and particularly preferably an ethylenic unsaturated double-bonding group or a ring-opening polymerizable group.

A preferred inorganic fine particle surface modifier in the present invention is a curable resin having a metal alkoxide or an anionic group and an ethylenic unsaturated double-bonding group or a ring-opening polymerizable group in the same molecule. When the inorganic fine particles are chemically bonded with organic components, the crosslinking density of the hardcoat layer increases, and it is possible to increase pencil hardness.

Typical examples of these surface modifiers include unsaturated double bond-containing coupling agents, phosphoric acid group-containing organic curable resins, sulfuric acid group-containing organic curable resins, carboxylic acid group-containing organic curable resins, all of which will be described below, and the like.

H₂C═C(X)COOC₃H₆Si(OCH₃)₃ S-1

H₂C═C(X)COOC₂H₄OTi(OC₂H₅)₃ S-2

H₂C═C(X)COOC₂H₄OCOC₅H₁₀OPO(OH)₂ S-3

(H₂C═C(X)COOC₂H₄OCOC₅H₁₀O)₂POOH S-4

H₂C═C(X)COOC₂H₄OSO₃H S-5

H₂C═C(X)COO(C₅H₁₀COO)₂H S-6

H₂C═C(X)COOC₅H₁₀COOH S-7

CH₂CH(O)CH₂OC₃H₆Si(OCH₃)₃ S-8

(X represents a hydrogen atom or CH₃)

The surfaces of these inorganic fine particles are preferably modified in a solution. When the inorganic fine particles are mechanically and finely dispersed, the surface modifier may be present together, the surface modifier may be added and stirred after the inorganic fine particles are finely dispersed, or, furthermore, the surfaces may be modified (by means of heating, drying and heating, or changing of pH as necessary) before the inorganic fine particles are finely dispersed and then fine dispersion may be carried out. The solution in which the surface modifier is dissolved is preferably a highly polar organic solvent. Specific examples thereof include well-known solvents such as alcohols, ketones, and esters.

The amount of the component e) added is preferably 5% to 40% by mass and more preferably 10% to 30% by mass in a case in which the total solid content in the composition for forming a hardcoat layer in the present invention is set to 100% by mass in consideration of the balance between the hardness and brittleness of coated films.

The size (average primary particle diameter) of the inorganic fine particles is preferably 10 nm to 100 nm and more preferably 10 to 60 nm. The average particle diameter of fine particles can be obtained from electron micrographs. When the particle diameters of the inorganic fine particles are too small, a hardness improvement effect cannot be obtained, and, when the particle diameters are too large, the composition may be hazed.

The shapes of the inorganic fine particles may be spherical or non-spherical, but two to ten inorganic fine particles are preferably coupled together so as to form non-spherical shapes from the viewpoint of imparting hardness. It is assumed that, when several inorganic fine particles coupled together so as to form chain-like shapes are used, a strong particle network structure is formed, and thus the hardness improves.

Specific examples of the inorganic fine particles include ELECOM V-8802 (spherical silica fine particles having an average particle diameter of 12 nm manufactured by JGC Corporation), ELECOM V-8803 (irregular silica fine particles manufactured by JGC Corporation), MiBK-SD (spherical silica fine particles having an average particle diameter of 10 to 20 nm manufactured by Nissan Chemical Industries, Ltd.), MEK-AC-2140Z (spherical silica fine particles having an average particle diameter of 10 to 20 nm manufactured by Nissan Chemical Industries, Ltd.), MEK-AC-4130 (spherical silica fine particles having an average particle diameter of 40 to 50 nm manufactured by Nissan Chemical Industries, Ltd.), MiBK-SD-L (spherical silica fine particles having an average particle diameter of 40 to 50 nm manufactured by Nissan Chemical Industries, Ltd.), MEK-AC-5140Z (spherical silica fine particles having an average particle diameter of 70 to 100 nm manufactured by Nissan Chemical Industries, Ltd.), and the like. Among these, irregular ELECOM V-8803 is preferred from the viewpoint of imparting hardness.

[f) Ultraviolet Absorbing Agent]

The composition for forming a hardcoat layer in the present invention preferably includes f) an ultraviolet absorbing agent. The ultraviolet absorbing agent f) will also be referred to as component f).

Ultraviolet absorbing agents contribute to improving the durability of films. Particularly, in an aspect in which the hardcoat film of the present invention is used as a surface protective film in image display devices, the addition of an ultraviolet absorbing agent is effective. An ultraviolet-absorbing function can be provided only to transparent supports; however, when the thickness of transparent supports is reduced, the function degrades, and thus it is preferable to impart the ultraviolet absorbing function to the hardcoat layer as well. Ultraviolet absorbing agents that can be used in the present invention are not particularly limited, and examples thereof include compounds described in Paragraphs “0107” to “0185” of JP2006-184874A. High-molecular-weight ultraviolet absorbing agents can also be preferably used, and particularly, high-molecular-weight ultraviolet absorbing agents described in JP1994-148430A (JP-H06-148430A) are preferably used.

The amount of the component f) used varies depending on the type, usage condition, and the like of the compound, but is preferably 0.1% to 10% by mass in a case in which the total solid content of the composition for forming a hardcoat layer in the present invention is set to 100% by mass.

Examples of the component f) include UV-1 to 4, but are not limited thereto.

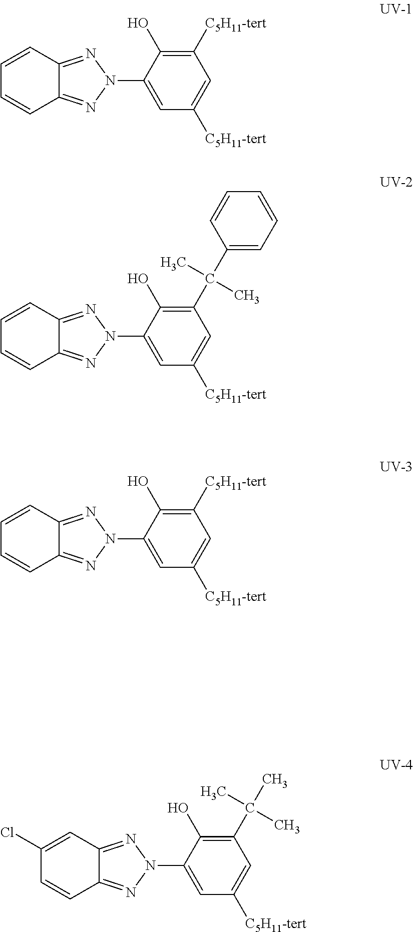

When the ultraviolet absorbing agent is used, the radical polymerization initiator c) is preferably selected so that the absorption wavelengths of the ultraviolet absorbing agent and the radical initiator do not overlap each other, and specifically, phosphine oxide-based compounds having absorption at long wavelengths: for example, bis(2,4,6-trimethylbenzoyl)-phenylphosphine oxide (for example, IRGACURE819 manufactured by BASF), bis(2,6-dimethoxybenzoyl)-2,4,4,-trimethyl-pentylphosphine oxide, and 2,4,6-trimethylbenzoyl-diphenyl-phosphine oxide (for example, LUCIRIN TPO manufactured by BASF) are preferred. When the radical initiator is used, it is possible to suppress curing inhibition by the ultraviolet absorbing agent. The cationic polymerization initiator d) is preferably combined with IRGACURE PAG 103, IRGACURE PAG 121, and CGI 725 which have absorption at long wavelengths.

In addition to the combination of the initiator having absorption at long wavelengths with the UV absorbing agent, it is preferable to jointly use a curing accelerator (sensitizing agent). When a sensitizing agent is combined, it is possible to decrease the amount of the polymerization initiator added or broaden the range of material selection. As sensitizing agents that can be jointly used, specific examples of light sensitizing agents include n-butylamine, triethylamine, tri-n-butylphosphine, Michler's ketones, thioxanthone, anthracene, diphenylbutadiene, distyrylbenzene, acridone, and the like.

[Solvent]

The composition for forming a hardcoat layer may include a solvent. As the solvent, it is possible to use a variety of solvents selected from the viewpoint of a capability of dissolving or dispersing the respective components, ease of forming uniform surface properties in coating steps and drying steps, capability of ensuring liquid preserving properties, and having an appropriate saturated vapor pressure, and the like.

It is also possible to use a mixture of two or more solvents. Particularly, the mixture preferably includes a solvent having a boiling point of 100° C. or lower at normal pressure and room temperature as a main component from the viewpoint of drying loads and includes a small amount of a solvent having a boiling point of higher than 100° C. in order for adjusting the drying speed.

In the composition for forming a hardcoat layer in the present invention, a solvent dissolving or swelling the support is preferably used in order to accelerate the infiltration of the solvent into the translucent support. Examples of the solvent dissolving or swelling the support include acetone, methyl acetate, butyl acetate, methyl acetoacetate, ethyl acetoacetate, chloroform, methylene chloride, trichloroethane, tetrahydrofuran, 2-butanone (methyl ethyl ketone), cyclohexanone, nitromethane, 1,4-dioxane, dioxolane, N-methyl pyrrolidone, N,N-dimethyl formamide, diisopropyl ether, methyl cellosolve, ethyl cellosolve, butyl cellosolve, dimethyl carbonate, diethyl carbonate, di-n-propyl carbonate, diisopropyl carbonate, methyl ethyl carbonate, methyl n-propyl carbonate, and ethyl n-propyl carbonate. Particularly, a solvent used in a case in which a base material is made of a cellulose-based resin or a (meth)acrylic resin is preferably methyl acetate, methyl acetoacetate, acetone, 2-butanone, cyclohexanone, dimethyl carbonate, or diethyl carbonate.

Examples of the solvent having a boiling point of 100° C. or lower include hydrocarbons such as hexane (boiling point: 68.7° C.), heptane (98.4° C.), cyclohexane (80.7° C.), and benzene (80.1° C.), halogenated hydrocarbons such as dichloromethane (39.8° C.), chloroform (61.2° C.), carbon tetrachloride (76.8° C.), 1,2-dichloroethane (83.5° C.), and trichloroethylene (87.2° C.), ethers such as diethyl ether (34.6° C.), diisopropyl ether (68.5° C.), dipropyl ether (90.5° C.), and tetrahydrofuran (66° C.), esters such as ethyl formate (54.2° C.), methyl acetate (57.8° C.), ethyl acetate (77.1C), and isopropyl acetate (89° C.), ketones such as acetone (56.1° C.) and 2-butanone (79.6° C. which is identical to the boiling point of methyl ethyl ketone), alcohols such as methanol (64.5° C.), ethanol (78.3° C.), 2-propanol (82.4° C.), and 1-propanol (97.2° C.), cyano compounds such as acetonitrile (81.6° C.) and propionitrile (97.4C), carbon disulfide (46.2° C.), and the like. Among these, ketones and esters are preferred, and ketones are particularly preferred. Among the ketones, 2-butanone is particularly preferred.

Examples of the solvent having a boiling point of higher than 100° C. include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (115.9° C. which is identical to the boiling point of MIBK), 1-butanol (117.7° C.), N,N-dimethyl formamide (153° C.), N,N-dimethylacetoamide (166° C.), dimethyl sulfoxide (189° C.), and the like. Cyclohexanone and 2-methyl-4-pentanone are preferred.

In the present invention, in a case in which the compound (a) is in a liquid phase, the composition for forming a hardcoat layer may or may not include a solvent, but preferably does not include any solvent. When the composition for forming a hardcoat layer does not include any solvent, the composition can be dried at a lower temperature, and thus low-molecular-weight compounds can be used, and step costs are suppressed, which is preferable.

(Surfactant)

It is also preferable to use a variety of surfactants in the composition for forming a hardcoat layer in the present invention. Generally, surfactants are capable of suppressing uneven film thicknesses caused by uneven drying attributed to the local distribution of drying air.

As the surfactant, specifically, the composition preferably includes a fluorine-based surfactant, a silicone-based surfactant, or both. In addition, the surfactant is preferably an oligomer or a polymer rather than a low-molecular-weight compound.

Preferred examples of the fluorine-based surfactant include fluoroaliphatic group-containing copolymers (hereinafter, also abbreviated as “fluorine-based polymers”), and, as the fluorine-based polymers, acrylic resins, methacrylic resins, and copolymers of an acrylic resin or a methacrylic resin and a vinyl-based monomer that can be copolymerized with acrylic resins and methacrylic resins, which includes a repeating unit that corresponds to a monomer of the following (i) or includes a repeating unit that corresponds to a monomer of the (i) and a repeating unit that corresponds to a monomer of the following (ii), are useful.

(i) Fluoroaliphatic Group-Containing Monomer Represented by the Following General Formula

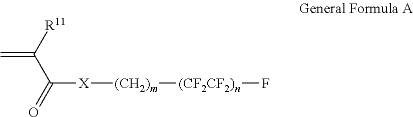

In General Formula A, R¹¹ represents a hydrogen atom or a methyl group, X represents an oxygen atom, a sulfur atom, or —N(R12)-, m represents an integer of 1 or more and 6 or less, and n represents an integer of 2 to 4. R12 represents a hydrogen atom or an alkyl group having 1 to 4 carbon atoms, specifically represents a methyl group, an ethyl group, a propyl group, or a butyl group, and is preferably a hydrogen atom or a methyl group. X is preferably an oxygen atom.

(ii) Monomer Represented by General Formula B Below which can be Copolymerized with the (i)

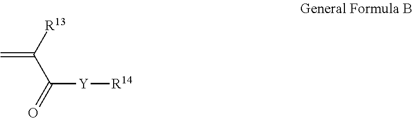

In General Formula B, R¹³ represents a hydrogen atom or a methyl group, Y represents an oxygen atom, a sulfur atom, or —N(R15)-, R15 represents a hydrogen atom or an alkyl group having 1 to 4 carbon atoms, specifically represents a methyl group, an ethyl group, a propyl group, or a butyl group, and is preferably a hydrogen atom or a methyl group. Y is preferably an oxygen atom, —N(H)—, —N(CH₃)—.

R¹⁴ represents a linear, branched, or cyclic alkyl group having 4 to 20 carbon atoms which may have a substituent. Examples of the substituent in the alkyl group as R¹⁴ include a hydroxyl group, an alkylcarbonyl group, an arylcarbonyl group, a carboxyl group, an alkyl ether group, an aryl ether group, halogen atoms such as a fluorine atom, a chlorine atom, and a bromine atom, a nitro group, a cyano group, an amino group, and the like but are not limited thereto. As the linear, branched, or cyclic alkyl group having 4 to 20 carbon atoms, monocyclic cycloalkyl groups such as a butyl group, a pentyl group, a hexyl group, a heptyl group, an octyl group, a nonyl group, a decyl group, an undecyl group, a dodecyl group, a tridecyl group, a tetradecyl group, a pentadecyl group, an octadecyl group, an eicosanyl group, a cyclohexyl group, and a cycloheptyl group which may have a linear shape or a branched shape and polycyclic cycloalkyl groups such as a bicycloheptyl group, a bicyclodecyl group, a tricycloundecyl group, a tetracyclododecyl group, an adamantyl group, a norbornyl group, and a tetracyclodecyl group are preferably used.

The amount of the fluoroaliphatic group-containing monomer represented by General Formula A which is used in the fluorine-based polymer is 10% by mole or more, preferably in a range of 15% to 70% by mole, and more preferably in a range of 20% to 60% by mole on the basis of individual monomers in the fluorine-based polymer.

A preferred mass average molecular weight of the fluorine-based polymer is preferably 3,000 to 100,000 and more preferably 5,000 to 80,000. Furthermore, a preferred amount of the fluorine-based polymer added is in a range of 0.001 to 5 parts by mass, still more preferably in a range of 0.005 to 3 parts by mass, and more preferably in a range of 0.01 to 1 part by mass with respect to 100 parts by mass of a coating fluid. When the amount of the fluorine-based polymer added is 0.001 parts by mass or more, the effect of the fluorine-based polymer added can be sufficiently obtained, and, when the amount is 5 parts by mass or less, a problem of coated films not being sufficiently dried or the performance of coated films being adversely affected is not caused.

Examples of a preferred silicone-based compound include “X-22-174DX”, “X-22-2426”, “X-22-164C”, and “X-22-176D” (all trade names) manufactured by Shin-Etsu Chemical Co., Ltd.; “FM-7725”, “FM-5521”, and “FM-6621” (all trade names) manufactured by Chisso Corporation; “DMS-U22” and “RMS-033” (all trade names) manufactured by Gelest, inc.; “SH200”, “DC 11PA”, “ST80PA”, “L7604”, “FZ-2105”, “L-7604”, “Y-7006”, “SS-2801” (all trade names) manufactured by Dow Corning Toray Co., Ltd.; “TSF400” (trade name) manufactured by Momentive Performance Materials Inc., and the like, but are not limited thereto.

The content of the silicone-based surfactant is preferably 0.01 to 0.5% by mass and more preferably 0.01 to 0.3% by mass in a case in which the total solid content of the composition for forming a hardcoat layer in the present invention is set to 100% by mass.

(Matting Particles)

The hardcoat layer may include matting particles having an average particle diameter of 1.0 to 10.0 μm and preferably 1.5 to 5.0 μm for the purpose of imparting internal scattering properties or imparting surface unevenness. In addition, the hardcoat layer may also include a high-molecular-weight compound, an inorganic lamellar compound, or the like in order to adjust the viscosity of coating fluids.

[Translucent Support]

The translucent support is preferably a film including the above-described thermoplastic resin.

The thickness of the translucent support is 25 μm or less, preferably 5 to 25 μm, and more preferably 10 to 25 μm.

[Low-Refractive Index Layer]

In the present invention, a low-refractive index layer can be formed on the hardcoat layer in order to impart a reflectivity-decreasing effect. The low-refractive index layer has a lower refractive index than the hardcoat layer, and the thickness thereof is preferably 50 to 200 nm, more preferably 70 to 150 nm, and most preferably 80 to 120 nm.

The refractive index of the low-refractive index layer is lower than the refractive index of the layer immediately below the low-refractive index layer and is preferably 1.20 to 1.55, more preferably 1.25 to 1.46, and particularly preferably 1.30 to 1.40. The thickness of the low-refractive index layer is preferably 50 to 200 nm and more preferably 70 to 100 nm. The low-refractive index layer is preferably obtained by curing a curable composition for forming the low-refractive index layer.

Examples of a preferred aspect of the curable composition for the low-refractive index layer include:

(1) a composition including a fluorine-containing compound having a crosslinking or polymerizable functional group,

(2) a composition including a hydrolysis condensate of a fluorine-containing organosilane material as a main component,

(3) a composition including a monomer having two or more ethylenic unsaturated groups and inorganic fine particles (particularly, inorganic fine particles having a hollow structure are preferred), and the like.

(1) and (2) also preferably include inorganic fine particles, and furthermore, inorganic fine particles which have a low refractive index and a hollow structure are particularly preferably used from the viewpoint of decreasing the refractive index or adjusting the added amount and refractive index of the inorganic fine particles.

(1) Fluorine-Containing Compound Having Crosslinking or Polymerizable Functional Group

Examples of the fluorine-containing compound having a crosslinking or polymerizable functional group include copolymers of a fluorine-containing monomer and a monomer having a crosslinking or polymerizable functional group. Specific examples of these fluorine-containing polymers are described in JP2003-222702A, JP2003-183322A, and the like.

As described in JP2000-17028A, a curing agent having a polymerizable unsaturated group may be appropriately jointly used with the above-described polymer. In addition, as described in JP2002-145952A, a compound having a fluorine-containing polyfunctional polymerizable unsaturated group may also be preferably jointly used. Examples of the compound having a polyfunctional polymerizable unsaturated group include the monomers having two or more ethylenic unsaturated groups which have been described as the curable resin compound for antiglare layers. In addition, the hydrolysis condensates of organosilane described in JP2004-170901A are also preferred, and the hydrolysis condensates of organosilane having a (meth)acryloyl group are particularly preferred. When jointly used, these compounds significantly improve abrasion resistance particularly in a case in which a compound having a polymerizable unsaturated group is used as the polymer main body, which is preferable.

In a case in which the polymer alone does not have sufficient curing properties, it is possible to impart necessary curing properties by blending a crosslinkable compound with the polymer. For example, in a case in which a polymer main body contains a hydroxyl group, a variety of amino compounds are preferably used as the curing agent. Amino compounds that are used as the crosslinkable compound are, for example, compounds having a total of two or more of any one or both of a hydroxyalkylamino group and an alkoxyalkylamino group, and specific examples thereof include melamine-based compounds, urea-based compounds, benzoguanamine-based compounds, glycoluril-based compounds, and the like. For the curing of these compounds, an organic acid or a salt thereof is preferably used.

(2) Composition Including Hydrolysis Condensate of Fluorine-Containing Organosilane Material as Main Component

The composition including a hydrolysis condensate of a fluorine-containing organosilane compound as a main component also preferably has a low refractive index and high hardness on coated film surfaces. For fluorinated alkyl groups, condensates of a compound containing (a) hydrolysable silanols at either or both terminal(s) and tetraalkoxysilane are preferred. Specific compositions are described in JP2002-265866A and JP317152B.

(3) Composition Including Monomer Having Two or More Ethylenic Unsaturated Groups and Inorganic Fine Particles Having Hollow Structure

Still another preferred aspect is a low-refractive index layer made up of low-refractive index particles and a binder. The low-refractive index particles may be organic or inorganic particles, but are preferably particles having pores therein. Specific examples of hollow particles are described in the section of silica-based particles of JP2002-79616A. The refractive index of the particles is preferably 1.15 to 1.40 and more preferably 1.20 to 1.30. Examples of the binder include monomers having two or more ethylenic unsaturated groups which are described in the section of the above-described antiglare layer.

To a composition for the low-refractive index layer which is used in the present invention, the above-described light radical polymerization initiator or heat radical polymerization initiator is preferably added. In a case in which the composition includes a radical polymerizable compound, the amount of the polymerization initiator being used is 1 to 10 parts by mass and preferably 1 to 5 parts by mass of the compound.

The low-refractive index layer that is used in the present invention can be jointly used with inorganic particles. In order to impart abrasion resistance, it is possible to use fine particles having a particle diameter that is 15% to 150%, preferably 30% to 100%, and more preferably 45% to 60% of the thickness of the low-refractive index layer.

To the low-refractive index layer in the present invention, it is possible to appropriately add well-known polysiloxane-based or fluorine-based antifouling agents, sliding agents, and the like in order to impart characteristics such as antifouling properties, water resistance, chemical resistance, and sliding properties.

Additives having a polysiloxane structure are preferably reactive group-containing polysiloxanes {for example, “KF-100T”, “X-22-169AS”, “KF-102”, “X-22-3701IE”, “X-22-164B”, “X-22-5002”, “X-22-173B”, “X-22-174D”. “X-22-167B”, “X-22-161AS” (trade names) all manufactured by Shin-Etsu Chemical Co., Ltd.; “AK-5”, “AK-30”, “AK-32” (trade names) all manufactured by Toagosei Co., Ltd.; “SILAPLANE FM0725”, and “SILAPLANE FM0721” (trade names) manufactured by Chisso Corporation, and the like}. In addition, silicone-based compounds descried in Tables 2 and 3 of JP2003-112383A can also be preferably used.

A fluorine-based compound is preferably a compound having a fluoroalkyl group. The fluoroalkyl group preferably has 1 to 20 carbon atoms and more preferably has 1 to 10 carbon atoms, may be linear (for example, —CF₂CF₃, —CH₂(CF₂)₄H, —CH₂(CF₂)₈CF₃, —CH₂CH₂(CF₂)₄H, or the like), may have a branched structure (for example, CH(CF₃)₂, CH₂CF(CF₃)₂, CH(CH₃)CF₂CF₃, CH(CH₃)(CF₂)₅CF₂H, or the like), or may have an alicyclic structure (preferably a five-membered ring or a six-membered ring, for example, a perfluorocyclohexyl group, a perfluorocyclopentyl group, an alkyl group substituted with the above-described group, or the like), and may have an ether bond (for example, CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H, or the like). The compound may have a plurality of the fluoroalkyl groups in the same molecule.

Furthermore, the fluorine-based compound preferably has substituents that form a bond with a low-refractive index layer membrane or impart compatibility. The substituents may be identical to or different from each other, and the number of the substituents is preferably plural. Examples of a preferred substituent include an acryloyl group, a methacryloyl group, a vinyl group, an aryl group, a cinnamoyl group, an epoxy group, an oxetanyl group, a hydroxyl group, a polyoxyalkylene group, a carboxyl group, an amino group, and the like. The fluorine-based compound may be a polymer or an oligomer with a compound having no fluorine atoms, and the molecular weight thereof is not particularly limited. The content of fluorine atoms in the fluorine-based compound is not particularly limited, but is preferably 20% by mass or more, particularly preferably 30% to 70% by mass, and most preferably 40% to 70% by mass. Examples of a preferred fluorine-based compound include R-2020, M-2020, R-3833, M-3833, OPTOOL DAC (all trade names) manufactured by Daikin Industries, Ltd., MEGAFACE F-171. F-172, F-179A, DIFENSA MCF-300, MCF-323 (all trade names) manufactured by Dainippon Printing Ink Manufacturing, and the like, but are not limited thereto.

The amount of the polysiloxane fluorine-based compound or a compound having a polysiloxane structure added is preferably in a range of 0.1% to 10% by mass and particularly preferably 1% to 5% by mass of the total solid content in the low-refractive index layer.

[Coating Method]

The hardcoat film of the present invention can be formed using coating methods described below, but the method is not limited thereto. Well-known methods such as a dip coating method, an air knife coating method, a curtain coating method, a roller coating method, a wire bar coating method, a gravure coating method, a slide coating method, an extrusion coating method (a die coating method) (refer to the specification of JP2003-164788A), and a micro gravure coating method can be used, and, among these, a micro gravure coating method and a die coating method are preferred.

[Drying and Curing Conditions]

Regarding drying and curing methods in the manufacturing method of the present invention, preferred examples will be described below.

In the present invention, it is effective to cure the compound by combining radiation of ionizing radiation and a thermal treatment carried out before the radiation, at the same time as the radiation, or after the radiation.

Hereinafter, several patterns of manufacturing steps will be described, but the pattern is not limited thereto. (“−” in the following description indicates that no thermal treatments are carried out.)

Before radiation→at the same time as radiation→after radiation
(1) Thermal treatment→ionizing radiation curing→-
(2) Thermal treatment→ionizing radiation curing→thermal treatment
(3) -→ionizing radiation curing→thermal treatment

Additionally, a step in which a thermal treatment is carried out at the same time as ionizing radiation curing is also preferred.

In the present invention, as described above, it is preferable to carry out a thermal treatment in combination with radiation of ionizing radiation. Mixing of the polymerized substance of the compound having the energy ray-curable group and the thermoplastic resin can be controlled using the temperature of the thermal treatment before the radiation. In a case in which a thermal treatment is carried out at a high temperature, the polymerized substance of the compound having the energy ray-curable group is favorably mixed with the thermoplastic resin and can be permeated inside the thermoplastic resin, but there is a possibility that the compound is volatilized and impaired. The thermal treatment temperature is not particularly limited, but is preferably 40° C. to 150° C. and more preferably 40° C. to 80° C.

The time taken for the thermal treatment varies depending on the molecular weights of components being used, interactions with other components, viscosity, and the like, but is 15 seconds to one hour, preferably 20 seconds to 30 minutes, and most preferably 30 seconds to five minutes.

The type of the ionizing radiation is not particularly limited, and examples thereof include X-rays, electron beams, ultraviolet rays, visible light, infrared rays, and the like, and ultraviolet rays are broadly used. For example, for coated films that are ultraviolet-curable, individual layers are preferably cured by radiating ultraviolet rays at an irradiation level of 10 mJ/cm² to 1,000 mJ/cm² using an ultraviolet lamp. During radiation, the energy may be radiated once or can also be separately radiated. Particularly, since performance variation in the plane of coated films is alleviated or curling is improved, it is preferable to radiate ultraviolet rays two or more separate times, and it is preferable to radiate ultraviolet rays at a low irradiance level of 150 mJ/cm² or less in the initial stage and then radiate ultraviolet rays at a high irradiance level of 50 mJ/cm² or more and radiate ultraviolet rays at a high irradiance level in the latter stage than in the initial stage.

[Polarizing Plate]

The hardcoat film of the present invention can be used to produce a polarizing plate including a polarizer and at least one hardcoat film of the present invention.

The polarizing plate is made up of a polarizer and protective films disposed on both sides of the polarizer, and one or both protective films are preferably the hardcoat film of the present invention.

It is possible to use the hardcoat film of the present invention as one protective film and use an ordinary cellulose acetate film as the other protective film, but it is preferable to use a cellulose acetate film which is manufactured using a solution film-forming method and is stretched in the width direction in a roll film form at a stretching ratio of 10% to 100% as the other protective film. In addition, it is also possible to preferably use (meth)acrylic polymer films that have been recently proposed to be introduced as polarizing plate protective films.

In addition, it is also a preferred aspect in which, among the two protective films of the polarizer, the film other than the hardcoat film of the present invention is an optical compensation film having an optical compensation layer which is formed by including an optical anisotropic layer. Optical compensation films (phase difference films) are capable of improving the view angle characteristics of liquid crystal display screens. As the optical compensation films, well-known optical compensation films can be used, but optical compensation films described in JP2001-100042A are preferred from since the view angle broadens.

Examples of the polarizer include iodine-containing polarizing films, dye-based polarizing films for which dichroic dyes are used, and polyene-based optical films. Iodine-based polarizing films and dye-based polarizing films are generally manufactured using polyvinyl alcohol-based films.

In addition, as the polarizer, a well-known polarizer or a polarizer cut out from a long polarizing film in which the absorption axis of the polarizer is neither parallel nor perpendicular to the longitudinal direction may be used. The long polarizing film in which the absorption axis of the polarizer is neither parallel nor perpendicular to the longitudinal direction is manufactured using the following method.

That is, the polarizing film can be manufactured using a stretching method in which a polymer film such as a polyvinyl alcohol-based film being continuously supplied is stretched by imparting a tensile force while holding both ends of the polymer film using holding means so as to be stretched at least 1.1 to 20.0 times in the film width direction and the film-advancing direction is curved in the state of holding both ends of the film so that the difference in the advancing speed between both ends of the film in the longitudinal direction of a holding device is 3% or less and the angle formed between the advancing direction of the film and the substantial stretching direction of the film at the outlet of a step of holding both ends of the film reaches 20° to 70°. Particularly, a method in which the angle reaches 45° is preferably used from the viewpoint of productivity.

The method for stretching polymer films are described in detail in Paragraphs “0020” to “0030” of JP2002-86554A.

[Image display device]

The hardcoat film or the polarizing plate of the present invention can be used for image display devices such as liquid crystal display (LCD) devices, plasma display panels (PDP), electroluminescence displays (ELD), or cathode ray tube (CRT) display devices.

Particularly, liquid crystal display devices in which a liquid crystal cell and the polarizing plate of the present invention disposed on at least one surface of the liquid crystal cell are provided and the hardcoat film of the present invention is disposed on the outermost surface are preferred.

### EXAMPLES

Hereinafter, examples will be described in order to describe the present invention in detail, but the present invention is not limited to these examples.

(Preparation of Coating Fluid for Forming Hardcoat Layer)

Individual components were added according to compositions shown in Table 1 below and filtered using a polypropylene filter having a pore diameter of 10 μm, thereby preparing coating fluids for forming a hardcoat layer HC1 to HC19. Numerical values in Table 1 indicate the “% by mass” of the respective components.

Regarding solvents, the respective solvents were used at factions (% by mass) shown in Table 1 and were adjusted so that the solvent ratio reached values shown in Table 1. The solvent ratios are the fraction (% by mass) of solvents in the coating fluid for forming the hardcoat layer.

TABLE 1

| | | Example | | | | | | | | |
|---|---|---|---|---|---|---|---|---|---|---|
| | | HC1 | HC2 | HC3 | HC4 | HC5 | HC7 | HC8 | HC9 | HC10 |
| Monomer | ATMMT | 95.95% | 95.95% | 95.95% | 95.95% | 95.95% | 95.95% | 95.95% | | |
| | DPHA | | | | | | | | 95.95% | |
| | ATMPT | | | | | | | | | 95.95% |
| | TTA22 | | | | | | | | | |
| | Cyclomer M100 | | | | | | | | | |
| | CEL8000 | | | | | | | | | |
| | CEL2021P | | | | | | | | | |
| | UV1700B | | | | | | | | | |
| | M9050 | | | | | | | | | |
| Photopolymerization | Irg 127 | 4.00% | 4.00% | 4.00% | 4.00% | 4.00% | | | 4.00% | 4.00% |
| initiator | Irg 184 | | | | | | 4.00% | | | |
| | Irg 819 | | | | | | | 4.00% | | |
| | Irg 290 | | | | | | | | | |
| | B2380 | | | | | | | | | |
| | PAG-1 | | | | | | | | | |
| Wind variation | FP-1 | 0.05% | 0.05% | 0.05% | 0.05% | 0.05% | 0.05% | 0.05% | 0.05% | 0.05% |
| inhibitor | | | | | | | | | | |
| Solvent | MEK | 55% | 55% | 30% | 30% | 30% | 55% | 55% | 55% | 55% |
| | Methyl acetate | 45% | 45% | 70% | 70% | 70% | 45% | 45% | 45% | 45% |
| Solvent ratio | | 65% | 70% | 70% | 50% | 80% | 65% | 65% | 65% | 65% |

| | | | | | | | | | Reference | Comparative |
|---|---|---|---|---|---|---|---|---|---|---|
| | | Example | | | | | | | Example | Example |
| | | HC11 | HC12 | HC13 | HC14 | HC15 | HC16 | HC17 | HC18 | HC19 |
| Monomer | ATMMT | | | | | | | 7.62% | | |
| | DPHA | | | | | | | 68.54% | | |
| | ATMPT | | | | | | | | | |
| | TTA22 | 99.25% | 99.25% | 99.25% | | | | | | |
| | Cyclomer M100 | | | | 99.25% | | | 20.00% | | |
| | CEL8000 | | | | | 99.25% | | | | |
| | CEL2021P | | | | | | 99.25% | | | |
| | UV1700B | | | | | | | | 48.07% | 48.07% |
| | M9050 | | | | | | | | 48.07% | 48.07% |
| Photopolymerization | Irg 127 | | | | | | | 3.00% | | |
| initiator | Irg 184 | | | | | | | | 3.85% | 3.85% |
| | Irg 819 | | | | | | | | | |
| | Irg 290 | 0.70% | | | 0.70% | 0.70% | 0.70% | | | |
| | B2380 | | 0.70% | | | | | | | |
| | PAG-1 | | | 0.70% | | | | 0.80% | | |
| Wind variation | FP-1 | 0.05% | 0.05% | 0.05% | 0.05% | 0.05% | 0.05% | 0.05% | | |
| inhibitor | | | | | | | | | | |
| Solvent | MEK | | | | | | | 55% | 100% | 100% |
| | Methyl acetate | | | | | | | 45% | | |
| Solvent ratio | | 0% | 0% | 0% | 0% | 0% | 0% | 65% | 49% | 60% |

ATMMT: Pentaerythritol tetraacrylate (manufactured by Shin-Nakamura Chemical Co., Ltd.)

DPIIA: KAYARAD DPHA (manufactured by Nippon Kayaku Co., Ltd.)

ATMPT: Trimethylolpropane triacrylate (manufactured by Shin-Nakamura Chemical Co., Ltd.)

TTA22: Alicyclic epoxy monomer (manufactured by Jiangsu Tetrachem Co., Ltd.)

Cyclomer M100: Epoxy acrylate monomer (manufactured by Daicel Corporation)

CEL8000: Alicyclic epoxy monomer (manufactured by Daicel Corporation)

CEL2021P: Alicyclic epoxy monomer (manufactured by Daicel Corporation)

UV1700B: Urethane acrylate (manufactured by The Nippon Synthetic Chemical Industry Co., Ltd.)

M9050: Polyfunctional polyester acrylate (manufactured by Toagosei Co., Ltd.)

Irg 127: Irgacure 127, alkylphenone-based photopolymerization initiator (manufactured by BASF)

Irg 184: Irgacure 184, alkylphenone-based photopolymerization initiator (manufactured by BASF)

Irg 819: Irgacure 819, acylphosphine oxide-based photopolymerization initiator (manufactured by BASF)

Irg 290: Irgacure 290, sulfonium salt-based cationic polymerization initiator (manufactured by BASF)

B2380: Iodonium salt-based cationic polymerization initiator (manufactured by Tokyo Chemical Industry Co., Ltd.)

PAG-1: The following iodonium salt-based cationic polymerization initiator

PAG-1 was synthesized using the method described in Example 1 of JP4841935B.

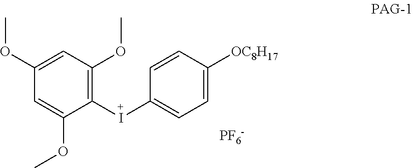

FP-1: The Following Fluorine-Containing Compound

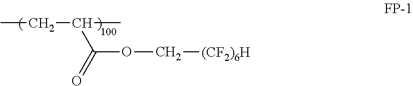

### MEK: Methyl Ethyl Ketone

### Examples 1 to 3 and 5 to 21, Reference Example, and Comparative Examples 1 and 2

Triacetyl cellulose (TAC) supports having a thickness shown in Table 3 were respectively coiled in a roll form, the coating fluids for forming the hardcoat layer HC1 to HC19 were used, and the coating amounts were adjusted so as to reach those shown in Table 2, thereby producing hardcoat films.

Specifically, the respective coating fluids were applied using a die coating method in which the slot die described in Example 1 of JP2006-122889A was used under a condition of a transportation speed of 30 m/minute, were dried at drying temperatures for drying times, which are shown in Table 2, and furthermore, monomers were cured by radiating ultraviolet rays at an illuminance of 400 mW/cm² and an irradiance level of 500 mJ/cm² using a 160 W/cm air-cooling metal halide lamp (manufactured by Eye Graphics Co., Ltd.) under nitrogen purging at an oxygen concentration of approximately 0.1% by volume and were then coiled.

### Example 4

A hardcoat film having both surfaces to which the coating fluid for forming a hardcoat layer had been applied was produced in the same manner as in Example 3 except for the fact that the hardcoat film produced in Example 3 was used as the support and HC3 was applied on a surface opposite to the surface to which the coating fluid for forming a hardcoat layer for the above-described hardcoat film had been applied.

### Examples 22 to 24

Hardcoat films were produced in the same manner as in Example 3 except for the fact that hardcoat layers were formed on acryl base material films produced using a method described below using coating fluids shown in Table 2.

(Production of 25 μm Acryl Base Material Films)

Methyl methacrylate (MMA) (8,000 g), methyl 2-(hydroxymethyl)acrylate (MHMA (2,000 g), and toluene (10,000 g) as a polymerization solvent were prepared in a reaction tank having an inner volume of 30 L which was equipped with a stirring device, a temperature sensor, a cooling pipe, and a nitrogen introduction pipe and were heated up to 105° C. under the flow of nitrogen. When reflux began in response to the heating, t-amyl peroxyisononanoate (10.0 g) were added thereto as a polymerization initiator, solution polymerization was caused to progress under reflux of approximately 105° C. to 110° C. while adding a solution made up of t-amyl peroxyisononanoate (20.0 g) and toluene (100 g) dropwise for two hours, and furthermore, aging was carried out for four hours. The polymerization reaction percentage was 96.6%, and the content percentage (mass ratio) of MHMA in the obtained polymer was 20.0%.

Next, a stearyl phosphate/distearyl phosphate mixture (manufactured by Sakai Chemical Industry Co., Ltd., Phoslex A-18) (10 g) was added thereto as a cyclization catalyst, and a cyclization condensation reaction was caused to progress for five hours under reflux of approximately 80° C. to 100° C.

Next, the obtained polymerized solution was introduced into a vent-type screw biaxial extruder (φ=29.75 mm, L/D=30) having a paddle temperature of 260° C., a rotation speed of 100 rpm, a degree of decompression of 13.3 to 400 hPa (10 to 300 mmHg), one rear vent, and four fore vent at a treatment speed of 2.0 kg/hour in terms of the amount of a resin, and a cyclization condensation reaction and devolatilization were carried out in the extruder. Next, after the end of the devolatilization, the resin in a thermally-melted state remaining in the extruder was discharged from the tip of the extruder and was pelletized using a pelletizer, thereby obtaining transparent pellets made of a (meth)acrylic resin having a lactone ring structure in the main chain. The weight-average molecular weight of this resin was 148,000, the melt flow rate (obtained according to JIS K7120 at a test temperature of 240° C. and a load of 10 kg, which shall apply to the subsequent manufacturing examples) was 11.0 g/10 minutes, and the glass transition temperature was 130° C.

Next, the obtained pellets and an AS resin (manufactured by Toyo Styrene Co., Ltd., trade name: TOYO AS AS20) were kneaded using a monoaxial extruder (φ=30 mm) in a mass ratio of 90/10 (pellets/AS resin), thereby obtaining transparent pellets having a glass transition temperature of 127° C.

The pellets of the resin composition produced above were melted and extruded from a coat hanger-type T die using a biaxial extruder, thereby producing a resin film having a thickness of approximately 100 μm.

Next, the obtained non-stretched resin film was biaxially stretched at the same time 2.0 times in the machine direction (longitudinal direction) and 2.0 times in the horizontal direction (width direction), thereby producing a polarizer protective film. The acryl base material film obtained as described above had a thickness of 25 μm, a full light transmittance of 92%, a haze of 0.3%, and a glass transition temperature of 127° C.

(Production of 10 μm Acryl Base Material Film)

Transparent pellets having a glass transition temperature of 127° C. which had been produced in the same manner as in the method for producing the 25 μm acryl base material film were melted and extruded from a coat hanger-type T die using a biaxial extruder, thereby producing a resin film having a thickness of approximately 40 μm.

Next, the obtained non-stretched resin film was biaxially stretched at the same time 2.0 times in the machine direction (longitudinal direction) and 2.0 times in the horizontal direction (width direction), thereby producing a film. The acryl base material film obtained as described above had a thickness of 10 μm, a full light transmittance of 92%, a haze of 0.25%, and a glass transition temperature of 127° C.

TABLE 2

| | Example | Example | Example | Example | Example | Example | Example |
|---|---|---|---|---|---|---|---|
| | 1 | 2 | 3 | 4 | 5 | 6 | 7 |
| Coating | 45 | 40 | 45 | 45 | 45 | 31 | 18 |
| amount/g/m² | | | | | | | |
| Drying | 80° C. | 80° C. | 80° C. | 80° C. | 120° C. | 80° C. | 80° C. |
| temperature | | | | | | | |
| Drying time | 60 | 60 | 60 | 60 | 60 | 60 | 60 |
| | seconds | seconds | seconds | seconds | seconds | seconds | seconds |
| | Example | Example | Example | Example | Example | Example | Example |
| | 8 | 9 | 10 | 11 | 12 | 13 | 14 |
| Coating | 31 | 18 | 9 | 45 | 45 | 45 | 45 |
| amount/g/m² | | | | | | | |
| Drying | 80° C. | 80° C. | 80° C. | 80° C. | 80° C. | 80° C. | 80° C. |
| temperature | | | | | | | |
| Drying time | 60 | 60 | 60 | 60 | 60 | 60 | 60 |
| | seconds | seconds | seconds | seconds | seconds | seconds | seconds |
| | Example | Example | Example | Example | Example | Example | Example |
| | 15 | 16 | 17 | 18 | 19 | 20 | 21 |
| Coating | 15 | 15 | 15 | 15 | 15 | 15 | 15 |
| amount/g/m² | | | | | | | |
| Drying | 60° C. | 60° C. | 60° C. | 60° C. | 60° C. | 60° C. | 60° C. |
| temperature | | | | | | | |
| Drying time | 150 | 150 | 150 | 150 | 150 | 150 | 150 |
| | seconds | seconds | seconds | seconds | seconds | seconds | seconds |

| | Example | Example | Example | Reference | Comparative | Comparative |
|---|---|---|---|---|---|---|
| | 22 | 23 | 24 | Example | Example 1 | Example 2 |
| Coating | 45 | 45 | 45 | 15 | 15 | 20 |
| amount/g/m² | | | | | | |
| Drying | 80° C. | 80° C. | 80° C. | 50° C. | 50° C. | 50° C. |
| temperature | | | | | | |
| Drying time | 60 | 60 | 60 | 30 | 30 | 30 |
| | seconds | seconds | seconds | seconds | seconds | seconds |

The produced hardcoat films were evaluated using the following evaluation methods.

(Film Thickness)

The thickness of the mixed layer and the thickness of the hardcoat layer in the produced hardcoat films were measured using an SEM. A cross-section was cut in the thickness direction of the hardcoat film using a microtome, then, was dyed with osmium acid, and then was observed using a SEM, thereby measuring the film thicknesses of the mixed layer and the hardcoat layer.

Here, the “hardcoat layer” refers to a region not including the resin constituting the support, and the “mixed layer” refers to a layer including the resin constituting the support and the polymerized substance of the compound having the energy ray-curable group included in the composition for forming the hardcoat layer. Meanwhile, in Examples 1 to 24, the resin derived from the support and the polymerized substance of the compound having the energy ray-curable group included in the composition for forming the hardcoat layer were mixed with each other across the entire region in the film thickness direction and thus formed the mixed layer, the hardcoat layer could not be confirmed, and no interfaces could be observed.

(Striped Wrinkles)

Striped wrinkles in the transportation direction on the coated surface of the hardcoat film were visually evaluated using the following standards. In Example 4, evaluation was carried out on one surface.

A: Parallel wrinkles in the transportation direction of the film were not visible.

B: There were a small number of parallel wrinkles in the transportation direction of the film, but there was no practical problem.

C: Parallel wrinkles in the transportation direction of the film were evidently visible, and there was a practical problem.

D: Parallel wrinkles in the transportation direction of the film were extremely evidently visible, and there was a practical problem.

(Uneven Interference)

A black polyethylene terephthalate film for preventing rear surface reflection was attached to the surface opposite to the coated side, and the coated side was visually observed, thereby evaluating uneven interference using the following evaluation standards.

A: No interference fringes were generated.

B: There were a small number of interference fringes.

(Curls)

The hardcoat film was cut into a size of 60 mm×60 mm, the humidity was adjusted for three or longer hours under conditions of a temperature of 25° C. and a relative humidity of 60%. After that, a weight was placed on the film so that the film end surface protruded 1 cm, and the rising height (=curl value) of the end surface was measured. This evaluation was carried out in the coating direction and a direction perpendicular to the coating direction, and the average of the values was evaluated.

(Presence Ratio of Film Support Resin)

The presence ratio of the support resin on the surface and the inside of the hardcoat film was measured using a time of flight-secondary ion mass spectrometry (TOF-SIMS). For the TOF-SIMS measurement of the surface, for example, a TRIFT II-type TOF-SIMS (trade name) manufactured by Phi Evans Co., Ltd. was used, and C1/(C1+C2)×100 was computed from the peak intensity ratio of distinct fragment ions attributed to molecules present on the film surface. For the presence ratio of the support resin in the film, the film was actually cut to a predetermined depth from the surface, and TOF-SIMS was measured for the surface generated due to the cutting.

For the percentages of the support resins in Table 3, “coated side”, “central part”, and “opposite coated side” respectively indicate the followings.

Coated side: The surface of the film coated with the hardcoat layer. No cutting.

Central part: Cut to half of the film thickness of the respective films of examples/reference example/comparative examples.

Opposite coated side: The surface opposite to the side of the film coated with the hardcoat layer. No cutting.

Here, C1 represents the concentration of the resin constituting the translucent support, and C2 represents the concentration of the polymerized substance of the compound having the energy ray-curable group. TOF-SIMS is specifically described in “Surface analysis technology library Secondary Ion Mass Analysis” edited by The Surface Science Society of Japan and published by Maruzen-Yushodo Company, Limited (1999).

(Moisture Permeability)

The moisture permeability was evaluated by measuring the weight (g) of water vapor passing through a specimen having an area of 1 m² in an atmosphere of a temperature of 40° C. and a relative humidity of 90% for 24 hours according to the testing methods for determination of the water vapour transmission rate (Dish Method) of JIS Z0208.

A: A moisture permeability of less than 100 g/m/day

B: A moisture permeability of 100 g/m/day or more and a moisture permeability of less than 200 g/m/day

C: A moisture permeability of 200 g/m/day or more and a moisture permeability of less than 400 g/m/day

D: A moisture permeability of 400 g/m/day or more

The evaluation results of the produced hardcoat films are shown in Tables 3 and 4.

TABLE 3

| | | | | | | | | Percentage of support | | | | | |
|---|---|---|---|---|---|---|---|---|---|---|---|---|---|
| | | | | | | | | resin in film (%) | | | Performance | | |
| | | | Thick- | Thickness | Percentage | Thickness | Molecular | | | Opposite | Uneven | | |
| | Support | Coating | ness of | of mixed | of mixed | of hardcoat | weight of | Coated | Central | coated | inter- | Striped | Curl |
| | resin | fluid | support | layer | layer | layer | monomer | side | part | side | ference | wrinkle | (mm) |
| Example 1 | TAC | HC1 | 25 μm | 25 μm | 100% | None | 352 | 30 | 40 | 60 | A | A | 1.0 |
| Example 2 | TAC | HC2 | 25 μm | 25 μm | 100% | None | 352 | 20 | 45 | 80 | A | A | 2.0 |
| Example 3 | TAC | HC3 | 25 μm | 25 μm | 100% | None | 352 | 10 | 50 | 95 | A | B | 2.5 |
| Example 4 | TAC | HC3 | 25 μm | 25 μm | 100% | None | 352 | 5 | 25 | 5 | A | A | 0.0 |
| Example 5 | TAC | HC4 | 25 μm | 25 μm | 100% | None | 352 | 5 | 15 | 30 | A | A | 0.5 |
| Example 6 | TAC | HC5 | 25 μm | 25 μm | 100% | None | 352 | 50 | 65 | 70 | A | B | 0.5 |
| Example 7 | TAC | HC5 | 25 μm | 25 μm | 100% | None | 352 | 70 | 75 | 80 | A | A | 0.5 |
| Example 8 | TAC | HC1 | 15 μm | 15 μm | 100% | None | 352 | 30 | 40 | 60 | A | A | 1.0 |
| Example 9 | TAC | HC1 | 10 μm | 10 μm | 100% | None | 352 | 30 | 40 | 60 | A | A | 1.0 |
| Example 10 | TAC | HC1 | 5 μm | 5 μm | 100% | None | 352 | 30 | 40 | 60 | A | A | 1.0 |
| Example 11 | TAC | HC7 | 25 μm | 25 μm | 100% | None | 352 | 30 | 40 | 60 | A | A | 1.0 |
| Example 12 | TAC | HC8 | 25 μm | 25 μm | 100% | None | 352 | 30 | 40 | 60 | A | A | 1.0 |
| Example 13 | TAC | HC9 | 25 μm | 25 μm | 100% | None | 578 | 5 | 50 | 90 | A | A | 3.5 |
| Example 14 | TAC | HC10 | 25 μm | 25 μm | 100% | None | 296 | 30 | 40 | 60 | A | A | 1.0 |
| Example 15 | TAC | HC11 | 25 μm | 25 μm | 100% | None | 140 | 30 | 40 | 60 | A | A | 1.0 |
| Example 16 | TAC | HC12 | 25 μm | 25 μm | 100% | None | 140 | 30 | 40 | 60 | A | A | 1.0 |
| Example 17 | TAC | HC13 | 25 μm | 25 μm | 100% | None | 140 | 30 | 40 | 60 | A | A | 1.0 |
| Example 18 | TAC | HC14 | 25 μm | 25 μm | 100% | None | 196 | 30 | 40 | 60 | A | A | 1.0 |
| Example 19 | TAC | HC15 | 25 μm | 25 μm | 100% | None | 194 | 30 | 40 | 60 | A | A | 1.0 |
| Example 20 | TAC | HC16 | 25 μm | 25 μm | 100% | None | 252 | 30 | 40 | 60 | A | A | 1.0 |
| Example 21 | TAC | HC17 | 25 μm | 25 μm | 100% | None | 352, 578, | 30 | 40 | 60 | A | A | 1.0 |
| | | | | | | | 196 | | | | | | |
| Example 22 | Acryl | HC1 | 25 μm | 25 μm | 100% | None | 352 | 30 | 40 | 60 | A | A | 1.0 |
| Example 23 | Acryl | HC11 | 25 μm | 25 μm | 100% | None | 140 | 30 | 40 | 60 | A | A | 1.0 |
| Example 24 | Acryl | HC11 | 10 μm | 10 μm | 100% | None | 140 | 30 | 40 | 60 | A | A | 1.0 |
| Reference | TAC | HC18 | 40 μm | 5 μm | 13% | 7 μm | 2000, | 0 | 100 | 100 | A | B | 4.0 |
| Example | | | | | | | 418 | | | | | | |
| Comparative | TAC | HC18 | 25 μm | 5 μm | 20% | 7 μm | 2000, | 0 | 100 | 100 | A | D | 8.0 |
| Example 1 | | | | | | | 418 | | | | | | |
| Comparative | TAC | HC19 | 25 μm | 15 μm | 60% | 7 μm | 2000, | 0 | 40 | 100 | A | C | 6.0 |
| Example 2 | | | | | | | 418 | | | | | | |

TABLE 4

| | Moisture permeability |
|---|---|
| Example 1 | B |
| Example 2 | B |
| Example 3 | B |
| Example 4 | A |
| Example 5 | A |
| Example 6 | C |
| Example 7 | C |
| Example 8 | C |
| Example 9 | D |
| Example 10 | D |
| Example 11 | B |
| Example 12 | B |
| Example 13 | B |
| Example 14 | B |
| Example 15 | A |
| Example 16 | A |
| Example 17 | A |
| Example 18 | B |
| Example 19 | A |
| Example 20 | A |
| Example 21 | A |
| Example 22 | B |
| Example 23 | A |
| Example 24 | A |

In the hardcoat films of the examples, the thickness of the support used and the thickness of the hardcoat film (mixed layer) were identical to each other, and it is found from the percentages of the support resin that the polymerized substance of the compound having the energy ray-curable group permeated into the support across the entire region in the film thickness direction and the hardcoat layer was not formed.

It is found that, in the hardcoat films of the examples, compared with the comparative examples, uneven interference or striped wrinkles were barely generated and the degree of curling was small.

### INDUSTRIAL APPLICABILITY

According to the present invention, it is possible to provide a hardcoat film having a film thickness of 25 μm or less in which uneven interference, curls, and striped wrinkles are all significantly suppressed and a method for manufacturing the hardcoat film. In addition, it is possible to provide a polarizing plate and a liquid crystal display device which include the hardcoat film and of which the display quality is not impaired due to uneven interference, curls, and striped wrinkles.

The present invention has been described in detail with reference to specific embodiments, and it is evident to persons skilled in the art that a variety of modifications and corrections can be added within the spirit and scope of the present invention.

Priority is claimed on the basis of a Japanese patent application filed on Sep. 30, 2014 (JP2014-202476), the content of which is incorporated herein by reference.

What is claimed is:

1. A hardcoat film having a film thickness of 25 μm or less in which a polymerized substance of a compound having an energy ray-curable group and a resin are mixed across an entire region in a film thickness direction,
wherein a percentage of a mass concentration of the resin which is represented by the following Expression (1) has a distribution in which the percentage is maximized on at least one of two opposed surfaces, in the film thickness direction, of the hardcoat film or at a central part, in the film thickness direction, of the hardcoat film:
(the mass concentration of the resin)/{(a mass concentration of the polymerized substance of the compound having an energy ray-curable group)+(the mass concentration of the resin)}×100(%) Expression (1).

2. The hardcoat film according to claim 1,
wherein the percentage of the mass concentration of the resin is 70% a or less on at least one of two opposed surfaces, in the film thickness direction, of the hardcoat film.

3. The hardcoat film according to claim 1,
wherein the percentage of the mass concentration of the resin is minimized on one of two opposed surfaces, in the film thickness direction, of the hardcoat film and maximized on other of two opposed surfaces, in the film thickness direction, of the hardcoat film.

4. The hardcoat film according to claim 3,
wherein the percentages of the mass concentration of the resin on both of two opposed surfaces, in the film thickness direction, of the hardcoat film are different from each other by 10% to 85%.

5. The hardcoat film according to claim 1,
wherein the percentage of the mass concentration of the resin is maximized at the central part.

6. The hardcoat film according to claim 1,
wherein the resin is cellulose acylate.

7. The hardcoat film according to claim 1,
wherein the resin is a (meth)acrylic polymer.

8. The hardcoat film according to claim 1,
wherein the compound having an energy ray-curable group is a compound having at least one of an ethylenic unsaturated double-bonding group or an epoxy group.

9. The hardcoat film according to claim 1,
wherein the compound having an energy ray-curable group is a compound having one or more epoxy groups and one or more ethylenic unsaturated double-bonding groups in a molecule of the compound.

10. The hardcoat film according to claim 1,
wherein the compound having an energy ray-curable group is a compound having one or more (meth)acryloyl groups in a molecule of the compound.

11. The hardcoat film according to claim 1,
wherein a molecular weight of the compound having an energy ray-curable group is 600 or less.

12. A method for manufacturing the hardcoat film according to claim 1, comprising:
applying a composition comprising a compound having an energy ray-curable group onto a translucent support comprising a resin which has a thickness of 25 μm or less from at least one of two opposed surfaces, in a thickness direction, of the translucent support to be permeated across an entire region in the thickness direction of the translucent support; and then curing the compound having an energy ray-curable group by radiating ionizing radiation.

13. A polarizing plate comprising:
a polarizer; and
at least one of the hardcoat film according to claim 1.

14. A liquid crystal display device comprising:
at least one of the hardcoat film according to claim 1.
